(19) United States
(12) Patent Application Publication
(10) Pub. No.: US 2025/0375944 A1
(43) Pub. Date: Dec. 11, 2025

(54) ASUSTEK COMPUTER INC.

(71) Applicant: ASUSTEK COMPUTER INC., TAIPEI (TW)

(72) Inventors: Yu-Chun HOU, TAIPEI (TW); Ming-Chung CHENG, TAIPEI (TW); Ching-Yang LEE, TAIPEI (TW); Chin-Hsiang CHANG, TAIPEI (TW); Yi-Shiau LIAU, TAIPEI (TW); Kai-Wen JENG, TAIPEI (TW); Hua-Kuo CHIN, TAIPEI (TW); Chian-Shiuan LIN, TAIPEI (TW); Yi-Ting LIN, TAIPEI (TW); Wei-Ning CHEN, TAIPEI (TW); Yi-Chuan LI, TAIPEI (TW)

(21) Appl. No.: 18/825,568

(22) Filed: Sep. 5, 2024

(30) Foreign Application Priority Data
Jun. 6, 2024 (TW) 113121059

(51) Int. Cl. B29C 70/54; B29C 70/46; B29K 105/08; B29K 307/04; B29L 31/34

(52) U.S. Cl. CPC B29C 70/545; B29C 70/46; B29K 2105/089; B29K 2307/04; B29L 2031/3481

(57) ABSTRACT

A manufacturing method for a case is provided. The manufacturing method includes: providing a plurality of pieces of fiber cloth; forming an opening in a part of the plurality of pieces of fiber cloth; stacking the plurality of pieces of fiber cloth to form a stacked structure, where the part of the plurality of pieces of fiber cloth with the opening is arranged on top to form a concave region on an upper surface of the stacked structure; and pressing a mold against the stacked structure, to form a case. The case has a concave structure at a position corresponding to the concave region.

### CROSS-REFERENCE TO RELATED APPLICATION

This application claims the priority benefit of Taiwan Application Serial No. 113121059, filed on Jun. 6, 2024. The entirety of the above-mentioned patent application is hereby incorporated by reference herein and made a part of specification.

### BACKGROUND OF THE INVENTION

### Field of the Invention

The disclosure relates to a manufacturing method for a case, and in particular, to a manufacturing method for a case of an electronic device.

### Description of the Related Art

A conventional manufacturing method for a carbon fiber reinforced plastic case is direct formation by hot pressing. When a concave structure is needed on a case surface for accessories to be placed, computer numerical control (CNC) machining needs to be performed on the case surface.

However, this manufacturing method has the following disadvantages. Firstly, a long duration of the CNC machining increases the time cost. Secondly, a CNC cutter has an external angle (R angle), which limits an outer shape of the concave structure to be formed, easily damages a carbon fiber structure of the case, and reduces the strength of the case.

### BRIEF SUMMARY OF THE INVENTION

The disclosure provides a manufacturing method for a case. The manufacturing method includes: providing a plurality of pieces of fiber cloth; forming an opening in a part of the plurality of pieces of fiber cloth; stacking the plurality of pieces of fiber cloth to form a stacked structure, where the part of the plurality of pieces of fiber cloth with the opening is arranged on top to form a concave region on an upper surface of the stacked structure; and pressing a mold against the stacked structure, to form a case. The case has a concave structure at a position corresponding to the concave region.

According to the manufacturing method for a case provided in the disclosure, the openings are formed in the parts of the fiber cloth, the stacked structure having the concave region on a surface thereof is formed by using these openings, and the case having the concave structure on the surface thereof is formed through pressing. In this way, a CNC process is simplified, manufacturing costs are reduced, and a problem of reduced strength of the case due to damage to a fiber structure as a result of use of a CNC cutter is avoided.

### BRIEF DESCRIPTION OF THE DRAWINGS

FIG. 1 is a flowchart showing a manufacturing method for a case according to an embodiment of the disclosure;

FIG. 2 shows an embodiment of a stacked structure formed in step S140;

FIG. 3 is a schematic diagram showing an embodiment of forming a case by pressing a mold against the stacked structure in step S160;

FIG. 4 is a schematic diagram showing an embodiment of performing surface machining on a side wall of a concave structure in step S180; and

FIG. 5 is a schematic cross-sectional diagram of a case manufactured according to a manufacturing method of another embodiment of the disclosure.

### DETAILED DESCRIPTION OF THE EMBODIMENTS

Specific embodiments of the disclosure are described in more detail below with reference to the schematic diagrams. Advantages and features of the disclosure are to be clearer according to the following descriptions and claims. It is to be noted that all the figures are in a very simple form and in an inaccurate proportion, and are merely intended to assist description of the purpose of the embodiments of the disclosure conveniently and clearly.

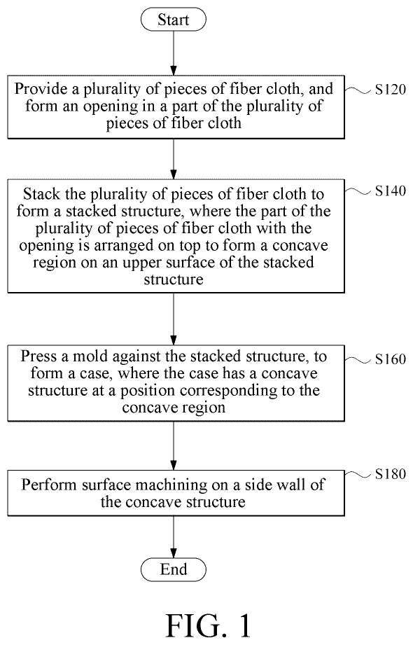

FIG. 1 is a flowchart showing a manufacturing method for a case according to an embodiment of the disclosure. The manufacturing method is suitable for manufacturing a case of an electronic device, and in an embodiment, suitable for manufacturing a case of an electronic device such as a notebook computer, a tablet computer, or a smartphone.

First, as described in step S120, a plurality of pieces of fiber cloth 22a, 22b is provided, and an opening 222 is formed in the fiber cloth 22a of the plurality of pieces of fiber cloth 22a, 22b. In an embodiment, the fiber cloth 22a, 22b provided in step S120 is pre-impregnated carbon fiber cloth.

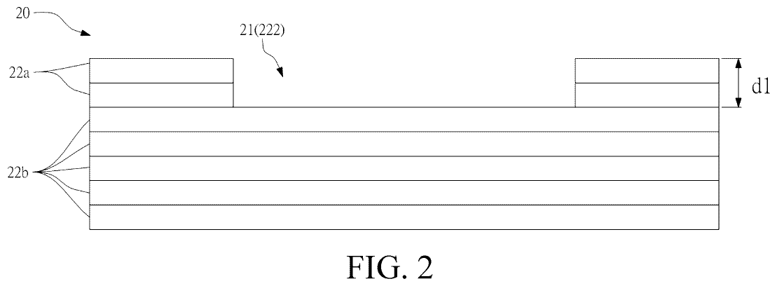

Then as described in step S140, the plurality of pieces of fiber cloth 22a, 22b is stacked to form a stacked structure 20. Referring to FIG. 2 together, FIG. 2 shows an embodiment of the stacked structure 20 formed in step S140. As shown in the figure, the fiber cloth 22a of the plurality of pieces of fiber cloth 22a, 22b with the opening 222 is arranged on top, and the openings 222 of the fiber cloth 22a are aligned with each other. However, a concave region 21 is formed on an upper surface of the stacked structure 20.

The stacked structure 20 formed in the embodiment of FIG. 2 has only one concave region 21. Based on actual design requirements, a quantity of openings 222 in the fiber cloth 22a is not limited to one, and a plurality of openings 222 is formed. After the plurality of pieces of fiber cloth 22a, 22b is stacked, the openings 222 form a plurality of concave regions 21, so as to present a varying outer shape.

In this embodiment, a quantity of the fiber cloth 22a of the fiber cloth 22a, 22b with the opening 222 is less than a quantity of all of the fiber cloth 22b, so as to ensure that the case formed by stacking the fiber cloth 22a, 22b maintains sufficient structural strength. Furthermore, in an embodiment, the quantity of the fiber cloth 22a of the fiber cloth 22a, 22b with the opening 222 is less than three. In this embodiment, the quantity of fiber cloth 22a with the opening 222 is 2, and the quantity of all of the fiber cloth 22a, 22b is 7.

Second, in this embodiment, the same opening 222 is formed in the fiber cloth 22a to stack the concave regions 21 with vertical side surfaces. Based on the actual design requirements, the openings 222 of the fiber cloth 22a have different shapes and sizes. In an embodiment, the fiber cloth 22a having a smaller opening 222 is arranged underneath the fiber cloth 22a having a larger opening 222, so as to form a substantially stepped concave region 21 in the stacked structure 20.

Then as described in step S160, a mold 30 is pressed against the stacked structure 20, to form a case 40. An outer shape of the mold 30 substantially corresponds to the concave region 21 on the stacked structure 20.

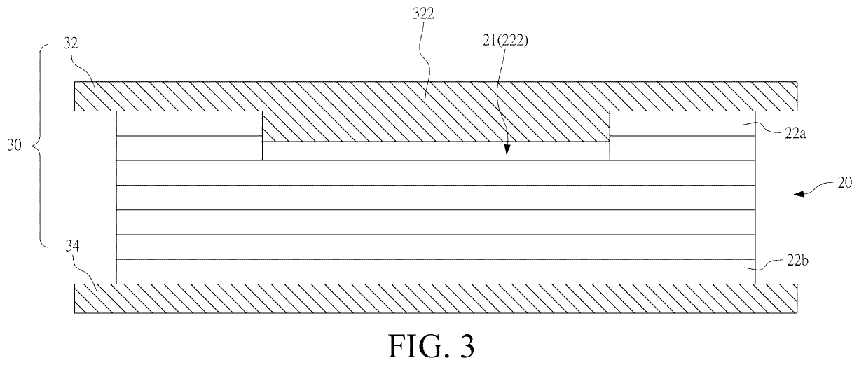

Referring to FIG. 3 together, FIG. 3 is a schematic diagram showing an embodiment of pressing a mold 30 against the stacked structure 20 to form a case in step S160. FIG. 3 shows an outer shape of the stacked structure 20 before the mold 30 is pressed.

Specifically, as shown in the figure, the mold 30 includes an upper part 32 and a lower part 34. An outer shape of the upper part 32 corresponds to the upper surface of the stacked structure 20, and a protruding portion 322 is provided at the position corresponding to the concave region 21 (that is, the opening 222 of the fiber cloth 22a) of the stacked structure 20.

A protruding distance of the protruding portion 322 is determined based on a size of the case 40 to be formed finally, and the protruding distance is less than a sum (that is, a thickness d1 in FIG. 2) of thicknesses of the fiber cloth 22a of the plurality of pieces of fiber cloth 22a, 22b in which the opening 222 is formed.

An outer shape of the lower part 34 at the position corresponding to the concave region 21 (that is, the opening 222 of the fiber cloth 22a) of the stacked structure 20 is substantially planar. Through press fit of the upper part 32 relative to the lower part 34, the stacked structure 20 is shaped, and the fiber cloth 22a, 22b is tightly bonded to form the case 40.

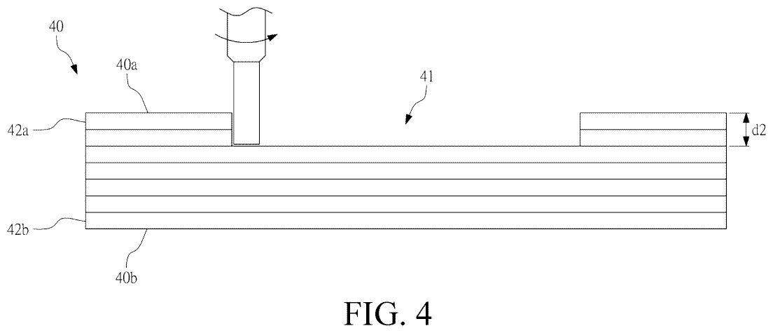

Referring to FIG. 4 together, FIG. 4 shows a case 40 formed by pressing a mold 30. The case 40 includes a plurality of fiber layers 42a and 42b that respectively correspond to the fiber cloth 22a, 22b of the stacked structure 20 before being pressed.

An upper surface 40a of the case 40 forms a corresponding concave structure 41 at a position corresponding to a protruding portion 322 of the mold 30. A depth d2 of the concave structure 41 is approximately equal to a protruding distance of the protruding portion 322 of the mold 30. A lower surface 40b of the case 40 is planar at the position corresponding to the protruding portion 322 of the mold 30.

Then as described in step S180, surface machining is performed on a side wall of the concave structure 41, to improve unevenness of the side wall of the concave structure 41 caused by misalignment of the fiber cloth 22a, 22b during stacking of the fiber cloth 22a, 22b.

In an embodiment, referring to FIG. 4 together, FIG. 4 is a schematic diagram showing an embodiment of performing surface machining on the side wall of the concave structure 41 in step S180. The side wall of the concave structure 41 of the case 40 is machined by using a milling cutter, to improve smoothness of the side surface of the concave structure 41.

It is to be noted that compared with the conventional CNC manufacturing method of using a milling cutter to cut a complete carbon fiber reinforced plastic case to form a groove, in this embodiment, only the side wall of the concave structure 41 of the case 40 needs to be machined, so as to effectively alleviate the problem of the reduced strength of the case 40 as a result of damage to the fiber structure of the case 40 due to CNC machining.

Furthermore, based on actual requirements, when the fiber cloth 22a, 22b has been accurately aligned, or the concave structure 41 is to be filled with another article in the subsequent process, step S180 is omitted.

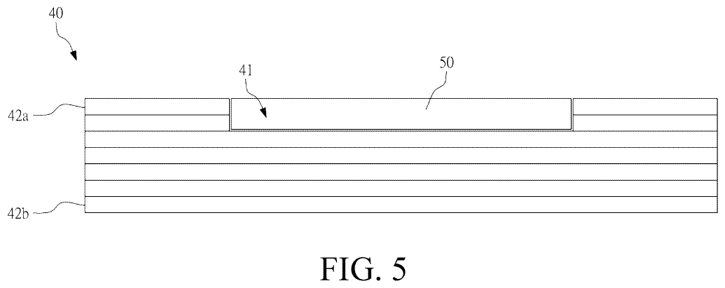

FIG. 5 is a schematic cross-sectional diagram of a case manufactured according to a manufacturing method of another embodiment of the disclosure.

As shown in the figure, based on actual requirements, after a case 40 is formed, a plate 50 (such as a nameplate) is further mounted to a concave structure 41 of the case 40, and a special surface texture is formed by using a material difference between the plate 50 and fiber layers 42a and 42b. In an embodiment, the plate 50 is a metal plate, and a surface of the plate 50 is substantially flush with an upper surface of a surrounding region of the concave structure 41 of the case 40. In an embodiment, a size of the plate 50 is approximately equal to a size of the concave structure 41, so as to form an appearance effect that the plate 50 is embedded in the case 40.

According to the manufacturing method for a case 40 provided in the disclosure, the openings 222 are formed in the fiber cloth 22a, the stacked structure 20 having the concave region 21 on a surface thereof is formed by using the openings 222, and the case 40 having the concave structure 41 on the surface thereof is formed through pressing. In this way, a CNC process is simplified, manufacturing costs are reduced, and a problem of reduced strength of the case 40 due to damage to the fiber structure of the case 40 as a result of use of a CNC cutter is avoided.

The above is merely preferred embodiments of the disclosure, and does not impose any limitation on the disclosure. Any form of change such as an equivalent replacement or modification made by any person skilled in the art to technical means and technical content provided in the disclosure without departing from scope of the technical means of the disclosure is content that does not deviate from the technical means of the disclosure, and still falls within the protection scope of the disclosure.

What is claimed is:

1. A manufacturing method for a case, comprising:
providing a plurality of pieces of fiber cloth;
forming an opening in a part of the plurality of pieces of fiber cloth;
stacking the plurality of pieces of fiber cloth to form a stacked structure, wherein the part of the plurality of pieces of fiber cloth with the openings is arranged on top to form a concave region on an upper surface of the stacked structure; and
pressing a mold against the stacked structure, to form a case, wherein the case comprises a concave structure at a position corresponding to the concave region.

2. The manufacturing method for a case according to claim 1, further comprising mounting a plate to the concave structure.

3. The manufacturing method for a case according to claim 1, further comprising performing surface machining on a side wall of the concave structure.

4. The manufacturing method for a case according to claim 3, wherein a step of performing surface machining on the side wall of the concave structure comprises performing surface machining on the side wall of the concave structure by using a milling cutter.

5. The manufacturing method for a case according to claim 1, wherein a step of stacking the plurality of pieces of fiber cloth to form the stacked structure comprises arranging the part of the fiber cloth with the opening on top of the stacked structure and aligning the openings with each other.

6. The manufacturing method for a case according to claim 1, wherein a quantity of the part of the plurality of pieces of fiber cloth with the opening is less than three.

7. The manufacturing method for a case according to claim 1, wherein the mold comprises an upper part and a lower part, and the upper part comprises a protruding portion at a position corresponding to the concave region.

8. The manufacturing method for a case according to claim 7, wherein a protruding distance of the protruding portion is less than a sum of thicknesses of the part of the plurality of pieces of fiber cloth with the opening.

9. The manufacturing method for a case according to claim 7, wherein the lower part is planar at a position corresponding to the concave region.

10. The manufacturing method for a case according to claim 1, wherein the fiber cloth is carbon fiber cloth.
